(19) United States
(12) Patent Application Publication
(10) Pub. No.: US 2007/0220014 A1
(43) Pub. Date: Sep. 20, 2007

(54) Data processing system and method

(75) Inventors: James M. Emling, Dousman, WI (US); Oliver Degnan, Menomonee Falls, WI (US)

Correspondence Address: FOLEY & LARDNER LLP, 777 EAST WISCONSIN AVENUE, MILWAUKEE, WI, 53202-5306, US

(73) Assignee: Zywave, Inc.

(21) Appl. No.: 11/701,970

(22) Filed: Feb. 2, 2007

Related U.S. Application Data
(60) Provisional application No. 60/764,899, filed on Feb. 3, 2006.
(60) Provisional application No. 60/775,482, filed on Feb. 21, 2006.
(60) Provisional application No. 60/802,353, filed on May 22, 2006.
(60) Provisional application No. 60/802,671, filed on May 23, 2006.
(60) Provisional application No. 60/812,689, filed on Jun. 9, 2006.

(51) Int. Cl. G06F 17/30

(52) U.S. Cl. 707/10

(57) ABSTRACT

Systems and methods are presented for storing a data file in at least one remote database. The data file that is stored in at least one database is displayed on the client device as a local system file in a file directory.

### CROSS-REFERENCE TO RELATED PATENT APPLICATIONS

The present application claims priority to U.S. Prov. Ser. No. 60/764,899, entitled “Data Processing System and Method,” filed Feb. 3, 2006; U.S. Prov. Ser. No. 60/775,482, entitled “Data Processing System and Method,” filed Feb. 21, 2006; U.S. Prov. Ser. No. 60/802,353 entitled “Data Processing System and Method,” filed May 22, 2006; U.S. Prov. Ser. No. 60/802,671, entitled “Data Processing System and Method,” filed May 23, 2006; and U.S. Prov. Ser. No. 60/812,689, entitled “Data Processing System and Method,” filed Jun. 9, 2006, all of which are hereby incorporated by reference herein.

### BACKGROUND

The present invention relates generally to the field of data and file management. More particularly, the present invention relates to the field of data management using a communication network, such as the Internet.

It is often desirable to share data through a communication network. For example, various application service providers (“ASPs”) exist which provide computer-based services to customers (i.e., users) of the ASP over the Internet. The computer-based services may include providing access to one or more software applications which execute on servers operated by the ASP and which are provided to the customers via the Internet. In order to effectively utilize the services provided by ASPs, it is often necessary for the users of the ASP to upload and download files to and from the ASP's central data center. As a further example, it is often desirable for companies to collaborate in real-time with its customers (or suppliers or other parties), such as on the creation of certain documents, presentations, or other files. Often, the process of sharing data through a network can become very tedious, particularly when the user desires to upload or download multiple files. Additionally, it is often tedious to access the files from other applications that may reside on the user's computer, e.g., for purposes of reading or modifying the file, for purposes of attaching the file to an e-mail, and so on. A challenge that has been encountered in providing a more seamless solution is that it is often desirable for customers to be able to use such files in combination with other network resources, such as applications or files available via a company intranet. Also, it is often desirable for multiple users (e.g., multiple employees at a company) to have common access to such files. It would be desirable to provide a more seamless integration of data files provided by an ASP's server with other resources available to users of the ASP.

Although certain features and advantages are described, it will be appreciated that the teachings herein may also be used to implement systems and methods that have other features and advantages different than those described.

### SUMMARY

One embodiment relates to a system and method, which includes a database coupled to a file server and an application service provider interface logic coupled to the file server. The application service provider interface logic being configured to receive commands via a communication network from a client device to access a data file in the database and to cooperate with the client device to cause the data file to be displayed as a local system file in a file directory on the client device.

Another embodiment relates to a database management system and method, which includes storing at least a data file in an application service provider database and receiving at least a file command from a plurality of client devices to an application service provider server. The database management system and method also includes displaying the data file as a local system file in a file directory on a client device.

Yet another embodiment relates to a system and method, which includes a database coupled to a file server. The system also includes a content template logic and an application service provider interface logic coupled to the file server. The application service provider interface logic being configured to receive commands via a communication network from a client device to access a data file in the database and to cooperate with the client device to cause the data file to be displayed as a local system file in a file directory on the client device.

Yet another embodiment relates to a system and method, which includes a database coupled to a file server. The system also includes a content template logic and an application service provider interface logic coupled to the file server, the application service provider interface logic being configured to receive commands via a communication network from a client device to access a data file in the database and to cooperate with the client device to cause the data file to be displayed as a local system file in a file directory on the client device. The file server cooperates with the client device to display a portion of a data file on the client device and the portion of a data file is configured to be modified by the client device. The modified data file is synchronized with the data file stored in the database and the application service provider interface logic receives at least a file command from a plurality of client devices and cooperates with the plurality of client devices to transmit a data file based on a control signal sent by a data access layer logic.

### BRIEF DESCRIPTION OF THE DRAWINGS

FIG. 1 is an illustration of a system for facilitating data management, according to one embodiment.

FIG. 2 is a screen shot of a browser-based user interface next to a screen shot of a desktop-based user interface showing remote files and folders, according to one embodiment.

FIG. 3 is an illustration of a system for facilitating data management, according to a more detailed example embodiment.

FIGS. 4A-4D are screen shots of a user interface for modifying a data file over a communication network using a data management system, according to one embodiment.

FIGS. 5 and 6 are screen shots of a user interface for saving a document in a data management system, according to one embodiment.

FIG. 7 is a screen shot of a user interface for attaching a document stored within a web-based application to an email utilizing a data management system, according to one embodiment.

FIG. 8 is a system architecture diagram showing aspects of the system of FIG. 3 in greater detail, according to one embodiment.

FIGS. 9A-9C are screen shots of a desktop taskbar icon, according to one embodiment.

FIG. 10 is a screen shot of a registry persistence, according to one embodiment.

FIG. 11 is an expanded illustration of a system for facilitating data management, according to one embodiment.

### DETAILED DESCRIPTION OF THE EXEMPLARY EMBODIMENTS

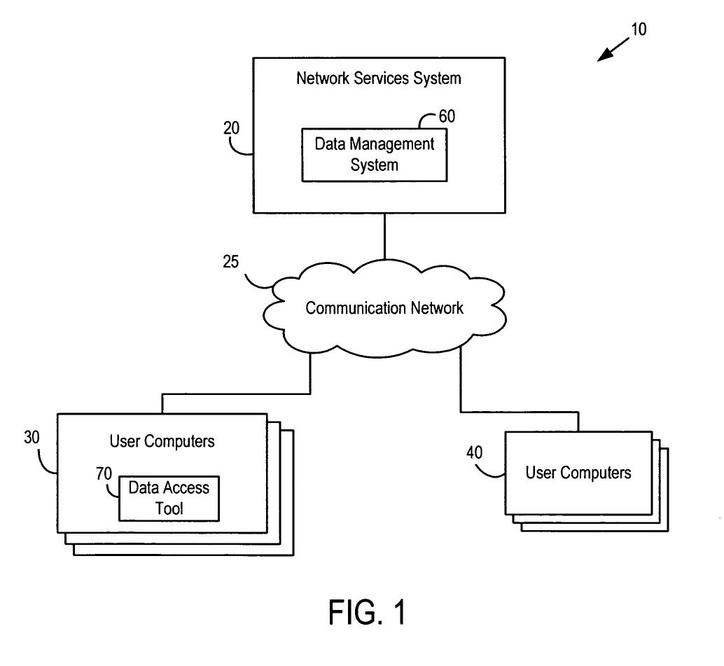

Referring now to FIG. 1, an embodiment of a system 10 is shown. The system 10 comprises a network services system 20, user computers 30, and user computers 40. The network services system 20 may, for example, comprise a computer system (e.g., one or more networked servers) operated by an application service provider or other entity. The network services system 20 may provide computer-based services to users through communication network 25, such as the Internet. The user computers 30 and 40 may each comprise individual or multiple computers connected to the communication network 25, individual or multiple computers connected to the communication network 25 through another network (e.g., an enterprise intranet), or other arrangements.

The network services system 20 permits user computers 30 and 40 to access data in the data management system 60 through computer network 25. The data may, for example, be accessed using a browser such as Internet Explorer®. (Internet Explorer® is a registered trademark of Microsoft Corporation.) In one embodiment, the user computers 30 and 40 include user computers 30 that have a data access tool 70. The data access tool 70 creates and maps a directory or file tree of files and folders corresponding to the remote files and folders stored at data management system 60 so that they are treated within the user's native operating environment (e.g., a Windows® operating system, an open source operating system, etc.) as though they are local files or folders. (Windows® is a registered trademark of Microsoft Corporation.) A local file is defined as any file stored within the client's computer, database or intranet (i.e. drives A: to Z:). For purposes of providing an example, it is assumed herein that the system 10 is used in connection with user computers 30, 40 having a Windows operating system, although it will be appreciated that other operating systems could also be used.

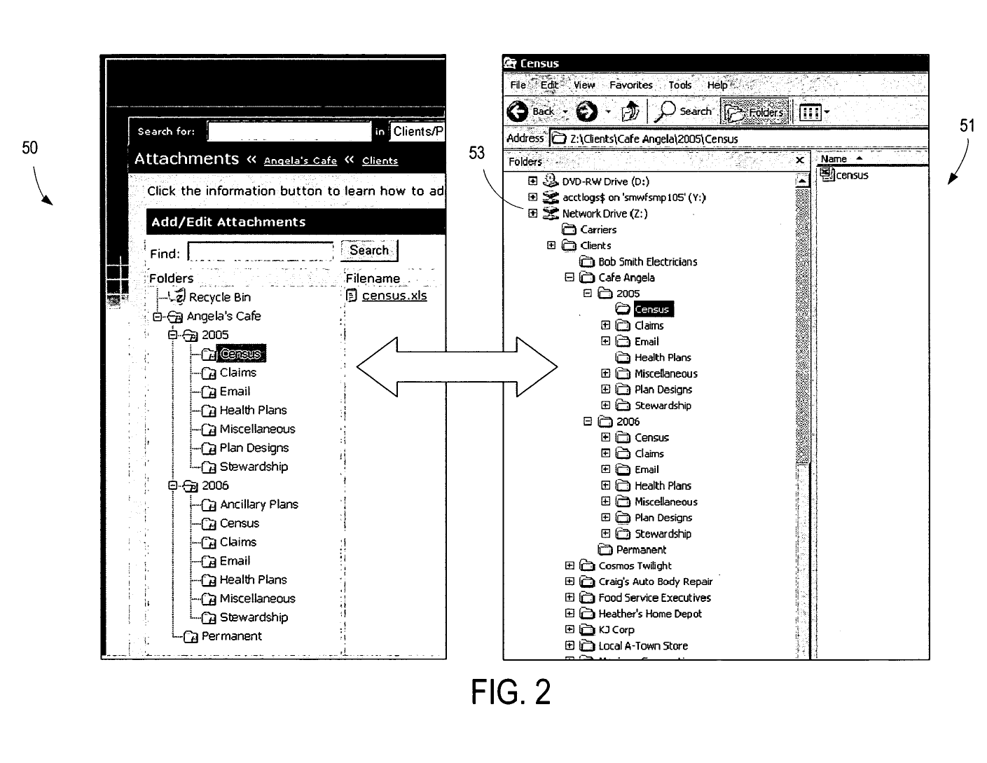

Referring now to FIG. 2, FIG. 2 is a screen shot of a browser-based user interface 50 next to a screen shot of a desktop-based user interface 51. The user interface 50 is provided by browser software and comprises a directory tree structure including various file folders and files within the file folders. The user interface 50 is configured to be readily understood by a user that is configured with a desktop file management application such as Windows Explorer, although the manner in which files are accessed is somewhat more tedious due to the manner in which browsers operate. To access a file, the user selects the file and then is prompted to specify a location for saving the file (e.g., on the user's local hard drive). After specifying a location for saving the file, a copy of the file is downloaded to the user's computer. Any edits that are made to the file are saved locally and not on the version of the file stored by data management system 60. If it is desired to save any edits to the version of the file stored by data management system 60, then the file is re-uploaded to data management system 60 using a process that mirrors in reverse the process for downloading the file.

The user interface 51 is provided using access tool 70 and comprises a directory structure including various file folders and files within the file folders. In one embodiment, as described in greater detail below, the access tool 70 creates and maps a directory or file tree of files and folders (corresponding to the remote files and folders) which appears within the user's Windows interface under a separate letter drive 53 (e.g., in FIG. 2, the Z: drive) just as the files and folders would appear if they were local files saved in the user's local hard drive. In other exemplary embodiments, the windows interface may be based on operating platforms, such as, Linux®, Unix®, Apple®, Palm OS®, Mozilla® or Netscape®. Linux is a registered trademark of Linux Mark Institute. Unix is a registered trademark of X/Open Company Ltd. Apple is a registered trademark of Apple Incorporated. Palm OS is a registered trademark of Palm Trademark Holding Company, LLC. Mozilla is a registered trademark on Mozilla Foundation. Netscape is a registered trademark of Netscape.

In addition to appearing within the user's Windows interface, the access tool 70 applies all default Windows functionality to the remote files and folders to enable the remote files and folders to be treated the same as a local file or folder would be treated in Windows and Windows-based applications or products. The access tool 70 allows the user to cut, copy, paste, delete, add, open/view, edit properties, move, rename, send, etc. the remote files just as if they were local files. In addition, the access tool 70 allows a user to move or copy multiple files and/or folders at once (drag-and-drop). Because the access tool 70 applies properties to the remote files and folders that mimic local files and folders, Windows-based applications and products recognize and work with the remote files and folders, in the same way they would with local files and folders. Accordingly, a user is able to scan documents directly into the remote folders; save documents to a remote folder directly from the user's local Windows-based applications; attach remote files to e-mails; save attachments from emails directly into a remote folder; view the total space used by a remote file or folder; and so on.

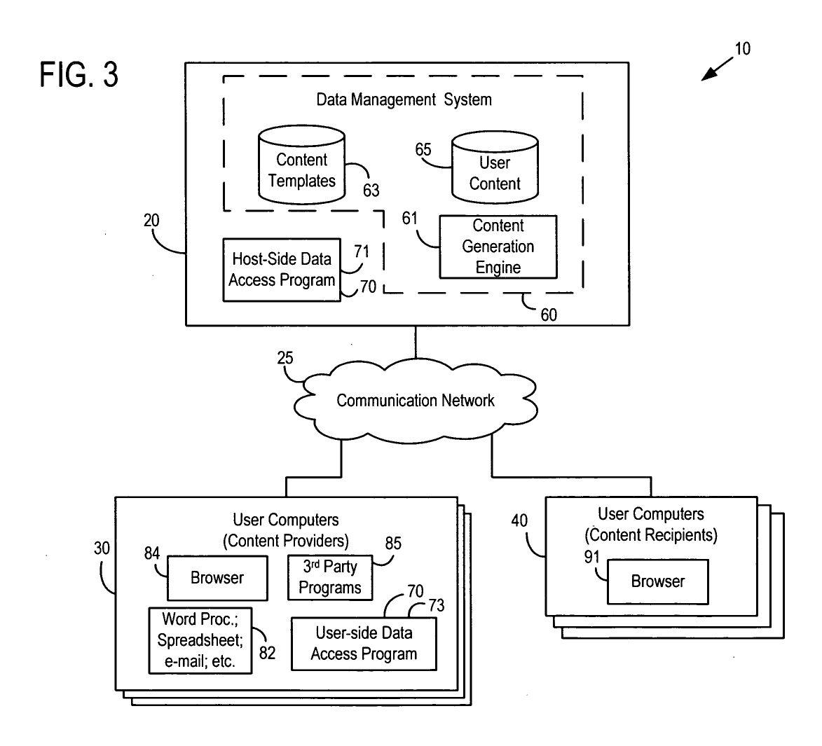

Referring now to FIG. 3, FIG. 3 is similar to FIG. 1 except that it provides a more detailed example. In the example of FIG. 3, the network services system 20 is shown as providing a content management system 60. The content management system 60 may be used to manage content such as documents (e.g., word processing documents, spreadsheet documents, graphics documents, etc.), media (e.g., music, video, etc.), or other content (e.g., technical data, medical/patient data, purchasing data, customer data, etc.). For purposes of providing an example, it will be assumed herein that the content management system 60 is used in connection with managing documents.

The users using user computers 30 and 40 may be entities (e.g., corporate entities, governmental entities, non-profit entities, and so on) and/or users that are private individuals (e.g., individuals acting on their own behalf). In the example of FIG. 3, the user computers 30 are shown as being associated with content providers and the user computers 40 are shown as being associated with content recipients. The content providers may, for example, be businesses (using user computers 30) that provide services to entities outside their institutional boundaries, e.g., to customers or clients (using user computers 40). In such an embodiment, the network services system 20 may be used to facilitate the delivery of content generated by one or more content providers to their customers or clients. Businesses that provide services to customers or clients and use the data management system 60 more extensively may utilize data access tool 70. Customers or clients may also utilize data access tool 70. Alternatively, if the customers or clients have less frequent interactions with the data management system 60, the customers or clients may prefer to access data management system 60 with a web browser, since it does not involve installation of additional software. As will be appreciated, in at least some instances, the content may be provided to the client or customer in another manner, e.g., in hardcopy format.

The content may be generated by the users using user computers 30, 40, by the data management system 60, and/or by another system. In the example of FIG. 3, the content is generated at least partially by the data management system 60. Thus, content management system 60 comprises content generation engine 61, content templates database 63, and user content database 65. (Herein, the term “database” refers to any data storage system.) Content generation engine 61 may be configured to access templates stored in templates database 63 and user-provided content stored in user database 65 and, using the templates and user-provided content, generate content that is suitable for presentation to the customers or clients. For example, if the content is documents, the content generation engine 61 may be configured to access document templates stored in database 63 and generate documents based on the templates. The templates may provide generic information, and the generation engine 61 may be used to generate custom documents based on the templates and based on context-specific information stored in user content database 65.

For example, if a report is to be generated by the content generation engine 61, then a content provider may store a spreadsheet file in user content database 65 that may contain raw data to be used by the content generation engine 61 to populate a report template to generate the report. The content provider may also store a word processing document containing other customized text for the report. The content generation engine 61 may then process the information contained in the spreadsheet file and/or the word processing file to generate the customized report. Other data may also be incorporated, for example, to incorporate logos or other branding information of the content provider. The content generation engine 61 may also access other sources of information and use that information to process information provided by the content provider. For example, if the spreadsheet specifies that a certain quantity of services has been provided, then content generation engine 61 may access a pricing engine that generates a price for each unit of services, so that the report includes a total fee for the services provided. Once the content (in this example, the report) is generated, it may be stored in user content database 65.

The content may be accessed by the content provider using the access tool 70. For example, the content provider may access the report to make final changes to the report before it is presented to the content recipient (e.g., to manually insert additional information into the report, to delete irrelevant text, etc.). Alternatively, the content provider may wish to modify a spreadsheet or the word processing document and then regenerate the report. In FIG. 3, the user computer 30 is shown as comprising other generic programs 82 which may be used to access and modify the content in the data management system 60 (e.g., word processing programs, spreadsheet programs, e-mail programs, presentation programs, media players, and so on). From the perspective of the user, such access may occur directly as though the report were located on the user's hard drive, without the need to download and save a local copy of the report from the data management system 60. The report may also be accessed by another access program 84 (e.g., a web browser, such as Internet Explorer using user interface 50) or by third party programs 85.

Access tool 70 is configured to permit users to access content stored by the data management system 60 outside of the user's web browser (e.g., Internet Explorer, Netscape, etc.). In FIG. 3, the access tool 70 is shown as comprising a host-side data access program (“host program”) 71 and a client-side data access program (“client program”) 73. According to one embodiment, the host program 71 is implemented using a WebDAV server. (Herein, “WebDAV” refers to Web-based Distributed Authoring and Versioning or the set of extensions to the HTTP protocol defined by the WebDAV Internet Engineering Task Force (IETF) working group which allows users to collaboratively edit and manage files on remote web servers.)

According to one embodiment, the client program 73 is a Windows® shell program that runs on a user's local system. According to one embodiment, the client program 73 creates and maps a directory or file tree of remote files and folders (corresponding to the remote content) which appears within the user's Windows interface under a separate letter drive (e.g., such as the Z: drive) just as the files and folders would appear if they were local files saved in the user's local hard drive. In addition to appearing within the user's Windows interface, the client program 73 applies all default Windows functionality to the remote files and folders to enable the remote files and folders to be treated the same as a local file or folder would be treated in Windows and Windows-based applications or products. For example, according to one embodiment, the basic folder and file level operations of Windows are applied to the remote files and folders. Thus, the data management system 60 provides users with easy and familiar access to all the folders, files, and attachments associated with the application provided over the Web by the network services system 20.

The client program 73 allows the user to cut, copy, paste, delete, add, open/view, edit properties, move, rename, send, etc. the remote files and folders just as if they were local files. In addition, the client program 73 allows a user to move or copy multiple files and/or folders at once (drag-and-drop). Because the client program 73 applies properties to the remote files and folders that mimic local or resident files and folders, Windows-based applications and products recognize and work with the remote files and folders, in the same way they would with local files and folders. Accordingly, a user is able to scan documents directly into the remote folders; save documents to a remote folder directly from the user's local Windows-based applications, such as word processing applications (e.g., Word®), spreadsheet applications (e.g., Excel®), presentation applications (e.g., PowerPoint®), etc.; attach remote files and folders to e-mails in e-mail applications (e.g., Outlook®); save attachments from emails directly into a remote folder; view the total space used by a file or folder; and so on.

In one embodiment, when the user accesses a remote file and edits it, the user accesses the file directly from the data management system 60. As the user makes changes to the file and saves those changes, the changes are saved directly at the data management system 60. No local cache copy of the document is made on the user's hard drive. Of course, if the user wishes to save a copy of the remote file on the user's local system, the user may do that by copying the file to the user's local system (e.g., the user's hard drive).

According to one embodiment, the access tool 70 synchronizes the directory listing or hierarchy of remote folders and files that appears within the user's system in real-time (or near real-time) with information concerning the directory listing of files and folders stored by the data management system 60. Thus, if a user creates a new file or folder in the virtual drive mapped by the client program 73, that file or folder will substantially instantaneously appear within the listing of files and folders provided by the data management system 60. The architecture (e.g., file structure) of the virtual drive may be cached locally to facilitate this synchronization process and to increase synchronization speed. An example of such a synchronization process includes storing a data file on an ASP server which can be retrieved by a local computing device, modifying the data file by utilizing the local computing device and saving the modified file to the ASP server. Another example includes a retrieving function that utilizes a customized customer file map and/or a computing device that processes a plurality of customer request to access/modify/save data files on the ASP.

The file structure of the virtual drive may be real or may be a logical construct. The files need not be physically stored in a manner which bears any particular relation to the file structures displayed to users. For example, all of the user files stored by data management system 60 may be stored in a single-level directory, and mapping logic may be used to map the files into multiple levels of logical folders and subfolders. According to one embodiment, the data management system 60 is configured to sort through each of these files and folders and create a virtual directory within a user's computer system (e.g., on the user's desktop) that includes (as remote files and folders) the folders and files to which a particular user has access rights.

According to one embodiment, the access tool 70 is configured to create a directory of remote files and folders within a user's system consisting only of those files for which the user has access rights and not those for which it does not have access rights. Accordingly, the user logging-in to the system of the network services system 20 through the access tool 70 is able to view only those files and folders the user is authorized to view. In some instances, multiple individuals from different entities may be able to view, edit, delete, etc. (depending on access rights) the same folder, file, or document or otherwise collaborate on the development of a file or document. Thus, if each content provider has a set of clients that accesses the user content database 65, each content provider may be given the ability to access its own data and that of its clients, but not the content of other content providers or their clients (i.e., assuming clients between the content providers do not overlap). Each content recipient may be given the ability to access its own content but not the content of any other content recipient or of any content provider.

As will be appreciated, different individuals within a given entity may also be given different levels of access rights. The folders and files included within the virtual directory created by the data management system 60 are displayed according to an appropriate set of business rules and access rights. The display provided to a particular user (including the files and folders displayed to the user) is determined based on the access rights of the user. Moreover, basic folder and file level operations (e.g., delete, add, open/view, edit (properties), move and rename) available to a particular user may be customized based on the rules of the application provided by the application service provide and user security rules.

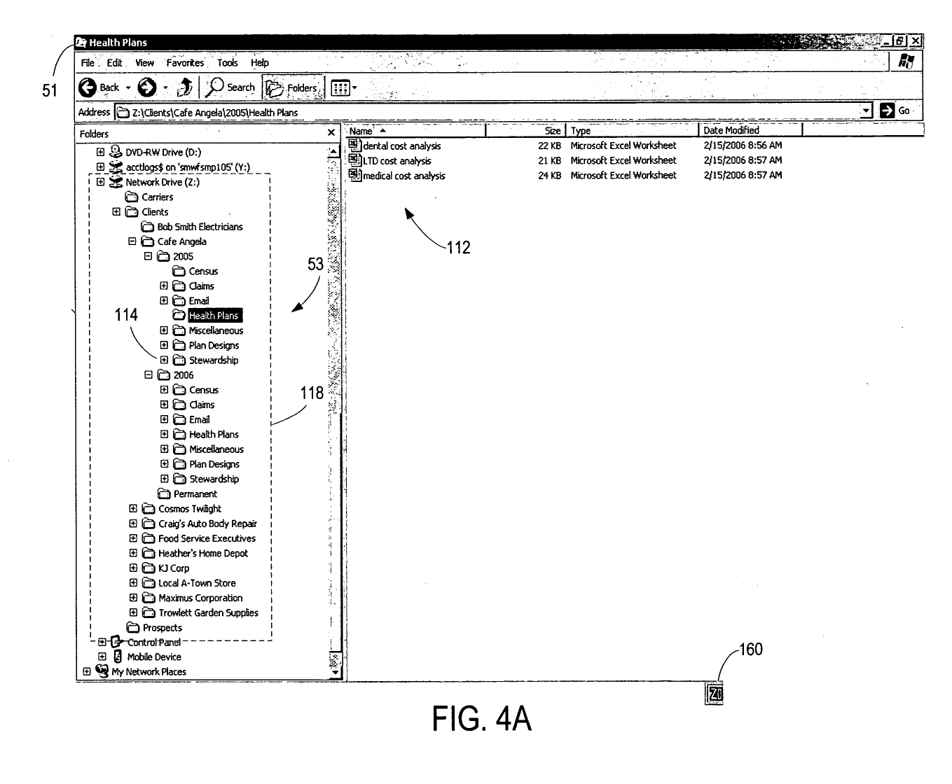

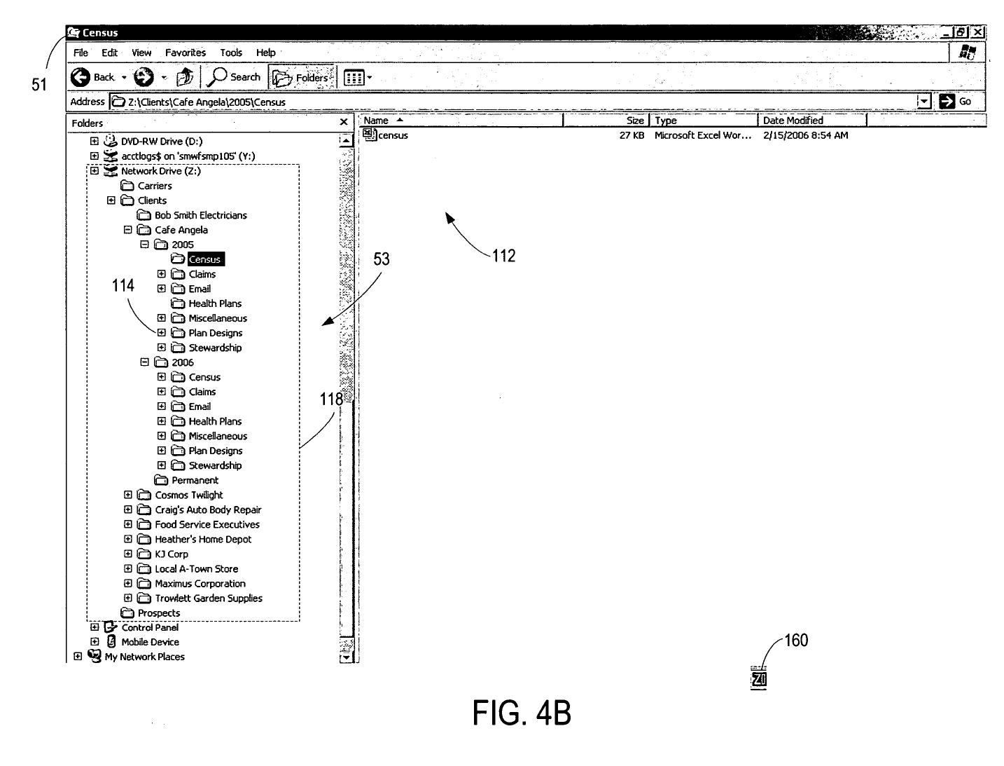

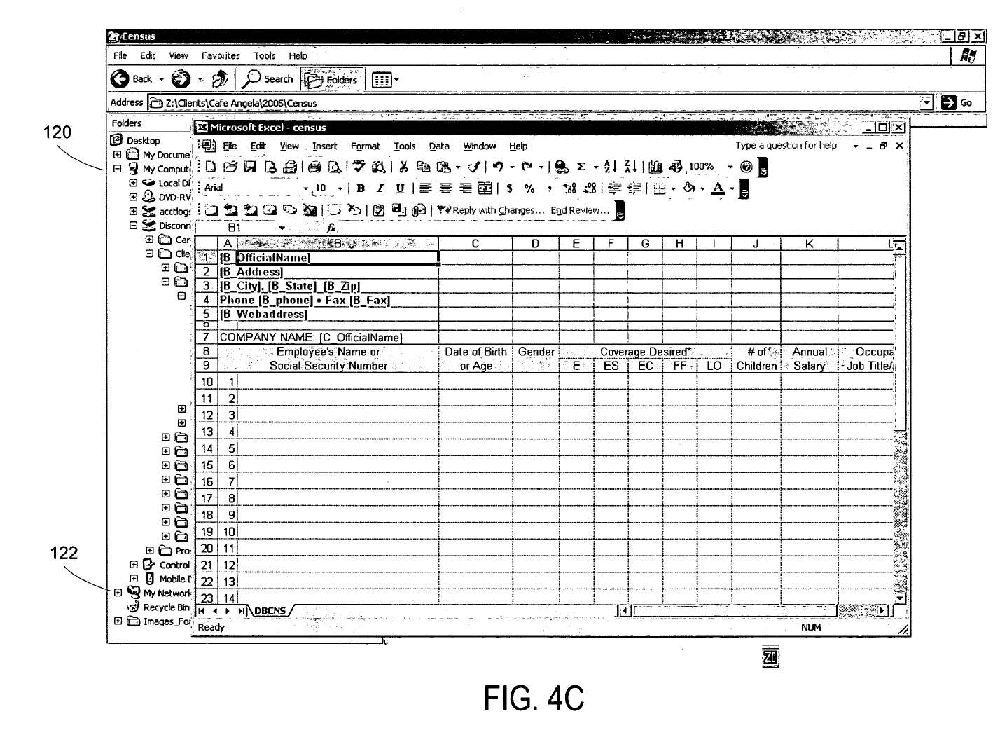

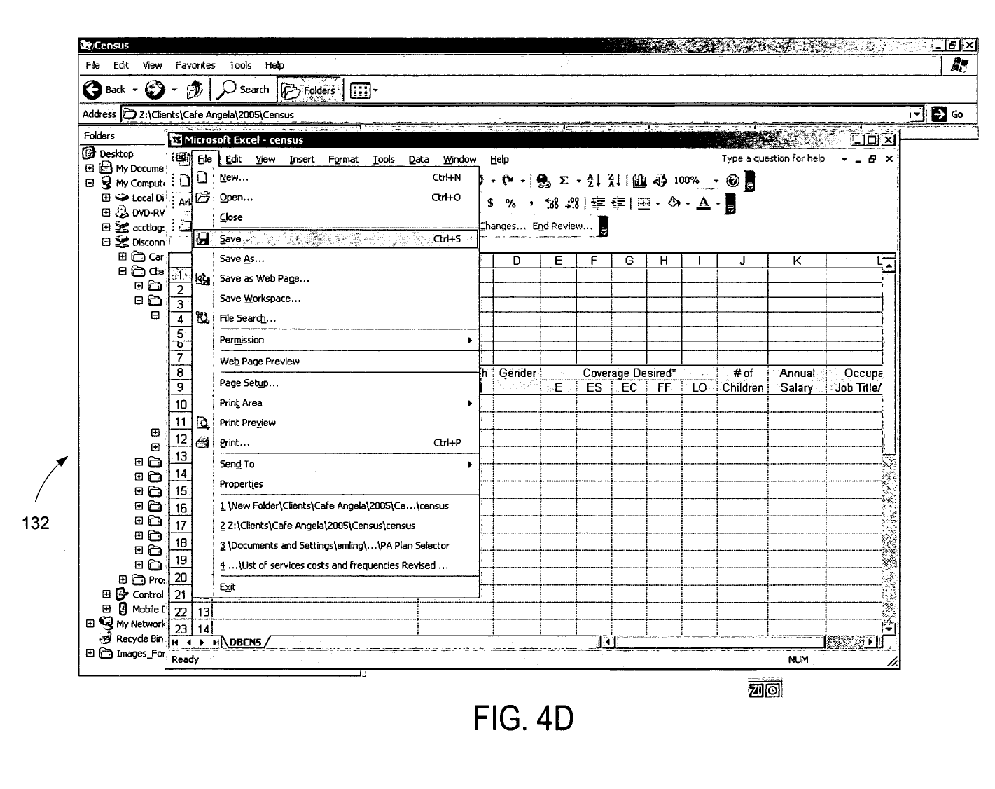

Referring now to FIGS. 4A-4D, the user interface 51 provided by client program 73 for data management system 60 is illustrated in greater detail. As illustrated in FIGS. 4A-4D, when the client program 73 is installed on the user's computer (or network), the client program 73 causes the user interface 51 to display files 112 and folders 114 on the user's computer as local files and folders in an application drive 53 (shown according to one embodiment as the Z: drive) within directory 118. The directory 118 has a file listing or file tree, which allows for the user to search for a specific file or folder. The user is able to manipulate and use the files 112 (e.g., cut, copy, paste, move, drag-and-drop, attach to Windows-based applications, etc.) in substantially the same way the user could manipulate and use their local files. The client program 73 runs in the background as a shell program and does not need to be explicitly “open” for the user to manipulate the user's files 112. Also, the data management system 60 allows a user to manage all of the application files 112 and folders 114 outside of a web browser. Thus, the user does not need a web browser to be open to manipulate or use the user's application files 112.

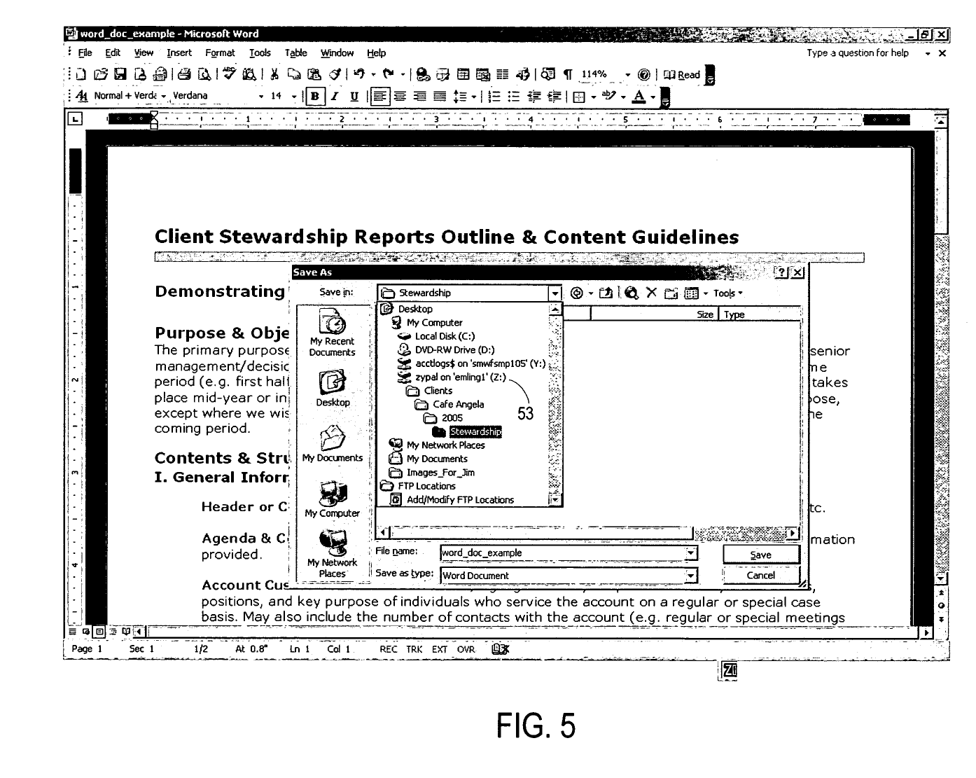

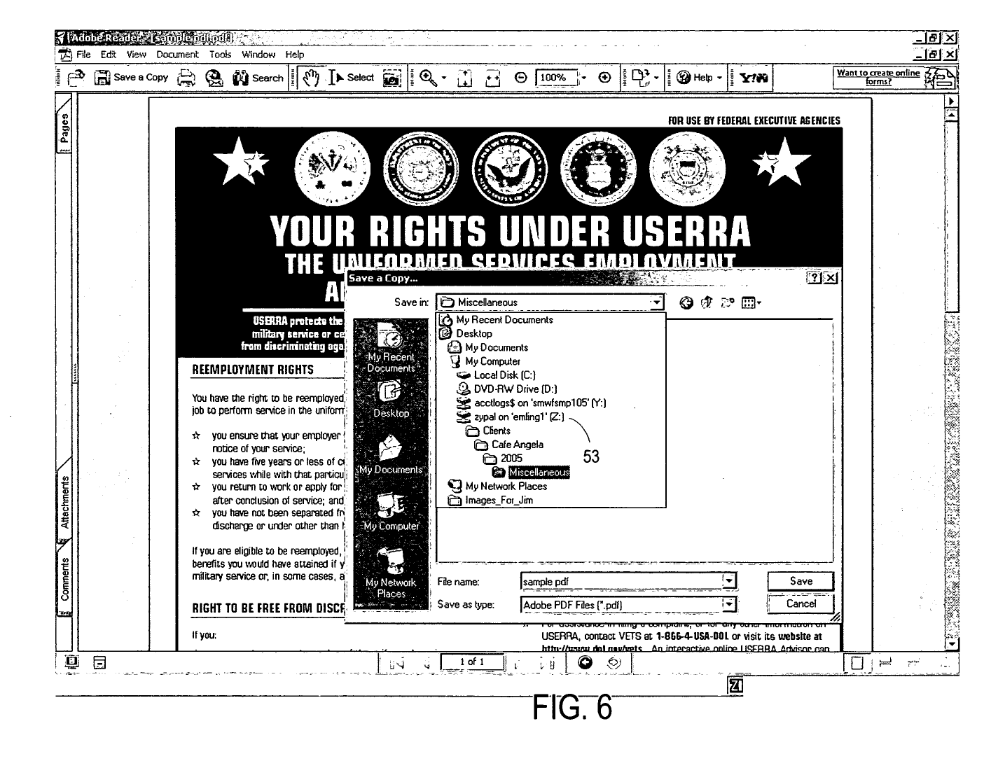

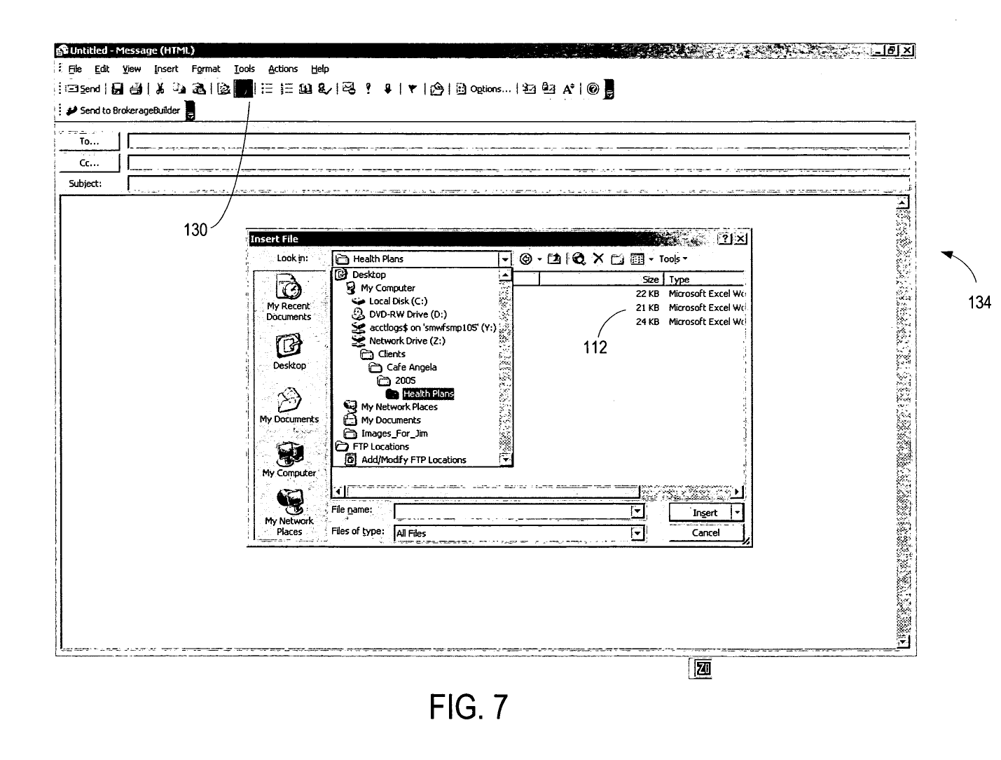

Accordingly, as illustrated in FIGS. 4A-4D, through the use of the data management system 60, a user is able to revise an application file 55 by opening the file 112 from the file tree 132, making the required changes, and then saving the file 112. If a user wants to add a file to the data management system 60, the user saves the document under the appropriate application drive 53. (See FIGS. 5 and 6). Further, if a user wants to add multiple files 112 (e.g., such as previously existing local files) to the data management system 60, the user may select the relevant files 112 and drag them to the appropriate location within the application drive 53. Similarly, if a user wants to email a file 112 from the data management system 60, the user may attach the file 112 to an email 134 using the same interface procedures required to attach a local file. (See FIG. 7). If the user changes the file tree structure of the application drive 53 (e.g., by adding a folder, deleting a folder, moving a file from one folder to another folder, etc.) within the user interface 51, the access tool 70 synchronizes the tree structure within the data management system 60 to conform to the user's changes in substantially real time.

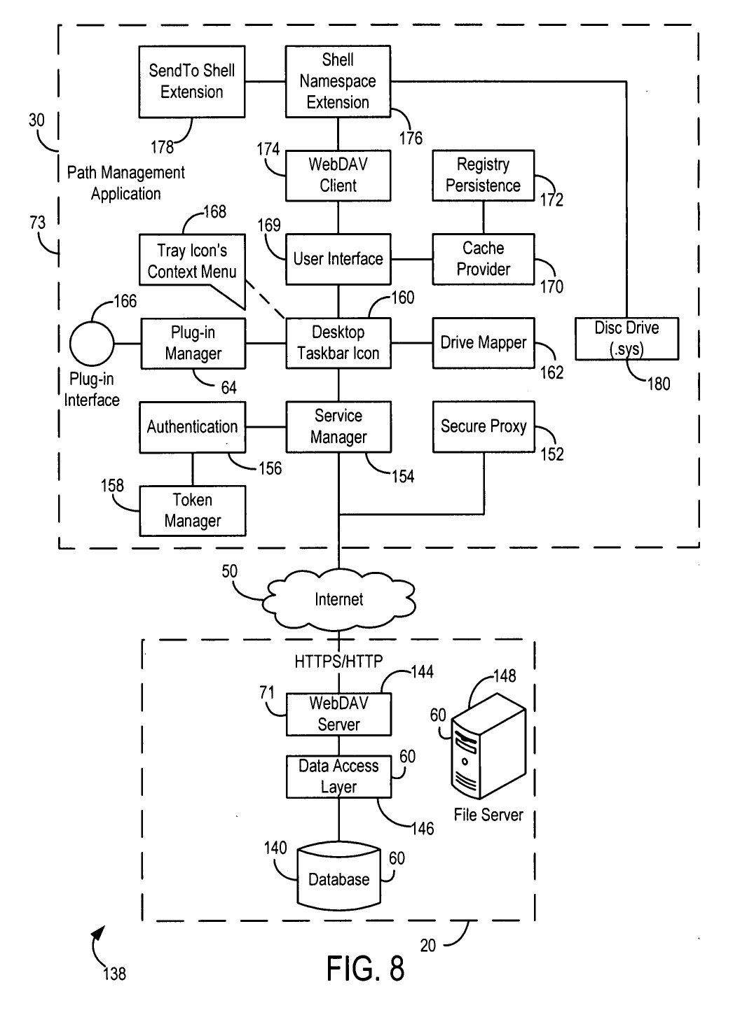

In FIG. 8 a high level system architecture 138 is shown. In one embodiment, the network services system includes a webdav server 144 coupled to a file server 148 and a data access layer 146 coupled to database 140. The webdav server 144 controls access to files stored in user content database 140. The data access layer 146 communicates with the database 140 to retrieve, send, index and store files 112.

The client program 73 has various program code to enable specific functions. According to one embodiment, the access tool 70 and the client program 73 make use of a combination of WebDAV, XML specifications, NET remoting, and SQL Server 2005 to achieve the functionality described herein. These functions are labeled as secure proxy 152, service manager 154, authentication logic 156, token manager 158, desktop taskbar icon logic 160, drive mapper 162, plug-in manager 164, plug-in interface 166, context menu logic 168, user interface logic 169, cache provider 170, registry persistence logic 172, webdav client 174, shell namespace extension logic 176, sendto shell extension logic 178 and disc driver logic 180.

The secure proxy 152 is a tunnel that forwards all requests made over HTTP port 80 to HTTPS port 443. The drive letters are mapped using the drive mapper 162 to the local location of http://localhost/files. In one embodiment, the secure proxy 152 then tunnels all requests to a secure https site. The user interface 51 does not show this transfer being completed. In another embodiment, the secure proxy 152 ensures that every user request has been authenticated and that valid network credentials exist. In one embodiment, the secure proxy 152 uses a process request method which is configured to avoid any popups of additional login prompts to re-authenticate.

The service manager 154 controls the mapping of an interface to a service implementation and provides for custom configuration of remoting channels which allows the a programmer to change the implementation of the service (e.g. moving from a NET remoting implementation to a SOAP HTTP service implementation) in a transparent fashion to the end user.

The authentication logic 156 (e.g. AuthChecker.cs) is responsible for authenticating the user's login credentials with the data management system 60 over HTTPS.NET remoting. The service manager 154 provides the required service interface contract to the authentication logic 156. The authentication logic 156 renews the authentication token on a periodic bases by communicating with data access layer 146. In one embodiment, the communication between the authentication 156 and the data access layer 146 utilizes the “UserDAL.Authenticate” method.

The token manager 158 allows local administrators (e.g. Help desk teams) to reset administrative functions (e.g. reset primary and secondary passwords). The desktop taskbar icon logic 160 provides a persistent image (See FIG. 4A) through which the user accesses service options including help menus. The user double clicks on the icon to open a new instance of Windows Explorer (explorer.exe). Windows Explorer is connected to the mapped application drive via the drive mapper 162.

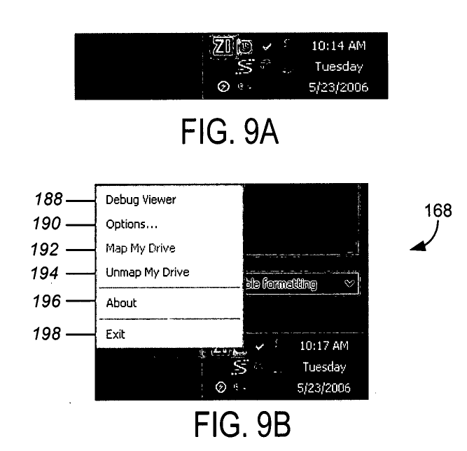

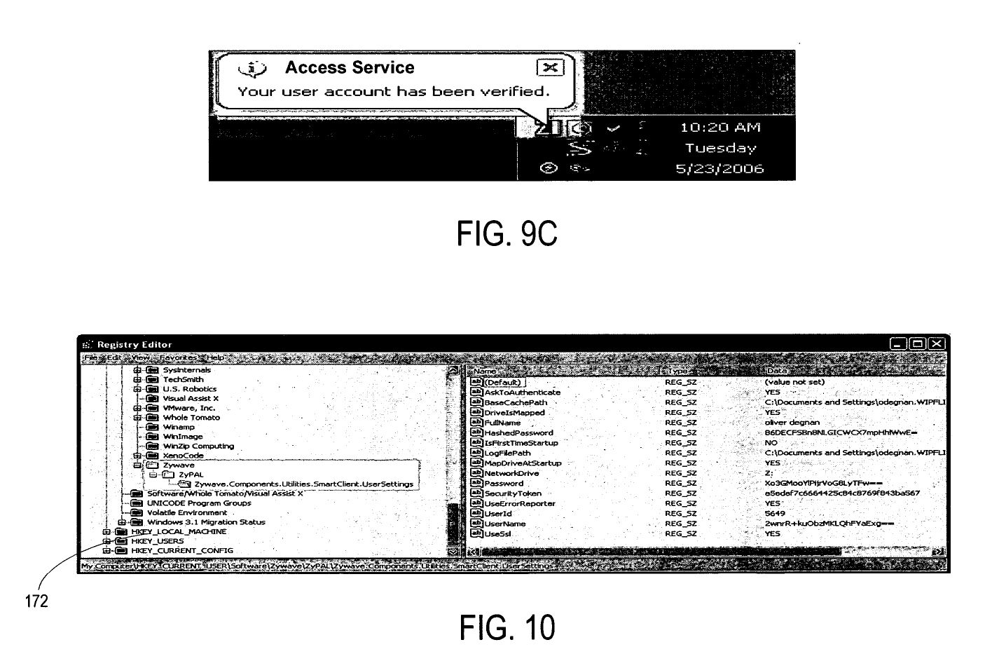

In FIGS. 9A-9C, exemplary embodiments of the desktop taskbar icon are shown. A tray icon's context menu 168 is displayed by right-clicking on the desktop taskbar icon 160. A debug viewer 188, options 190, map my drive 192, unmap my drive 194, about 196 and exit 198 are included in the menu options contained in the tray icon's context menu 168. As will be appreciated, other functions may also be displayed in the tray icon's context menu 168.

The user may utilize drive mapper 162 to select the desired drive letter to be mapped to http://localhost/files. The user selects the desired drive letter; however, sometimes the desired drive letter is already being used and mapped to a different location. In one embodiment, the drive mapper 162 iterates through all available (non-mapped) drive letters and choose the next available drive letter.

The plug-in manager 164 validates and loads all plug-ins from data management system 60. In one embodiment, all plug-ins are loaded into separate application domain to ensure that the plug-ins are kept separate from the client program 73 which enhances system reliability. The plug-in manager 164 utilizes a plug-in interface 166 device to communicate with the external accessory.

The cache provider 170 is configured to enable a method of marshalling classes transparently to different storage mechanisms. In one embodiment, the cache provider 170 could be filecache or a registrycache. The filecache stores data in the files. The registrycache stores data in the registry. The filecache can be provided in either XML or a binary format for backing the cache.

ICashe is the interface implemented by all of the cache backing schemes. Cache is a bridge or facade pattern that hides some of the complexity of interacting with the ICaches. CacheFactory is a factory pattern for the creation of ICaches, which allows for the option of registering ICache providers at runtime. XmlCache is a file based cache that serializes to XML. BinaryCache is a file based cache that serializes to a binary format. RegistryCache is a registry based cache that maps an object to registry entries.

In FIG. 10, the registry persistence 172 stores data that is use for persistent object classes. The persistent objects of client program 73 are stored in the Windows registry. The user interface logic 169 interacts with other Windows components to provide aspects of the user interface related to the client program as previously described.

The webdav client 174 controls access to application files 55. The webdav client 74 uses a list of authorized user to determine which users are allowed to collaboratively edit and manage application files 55.

The shell namespace extension 176 and send to shell extension 178 integrate the client program 73 with Windows Explorer. The shell namespace extension 176 causes the display that Windows Explorer generates to present the file system and other objects to the user to reflect objects (files, folders) associated with client program 73 to be displayed along with other objects, such as disk drive 180. The send to shell extension 178 integrates with Windows Explorer to respond to changes in directory structure of the virtual drive 53 (e.g., to reflect new files or folders).

According to various alternative and exemplary embodiments, the access tool 70 may be configured to enable real-time file collaboration; to enable the “pushing” of content and/or messages directly to the desktop of users, e.g., to launch new products, deliver content, or deliver key messages; to enable real-time instant messaging and/or support tickets; and so on.

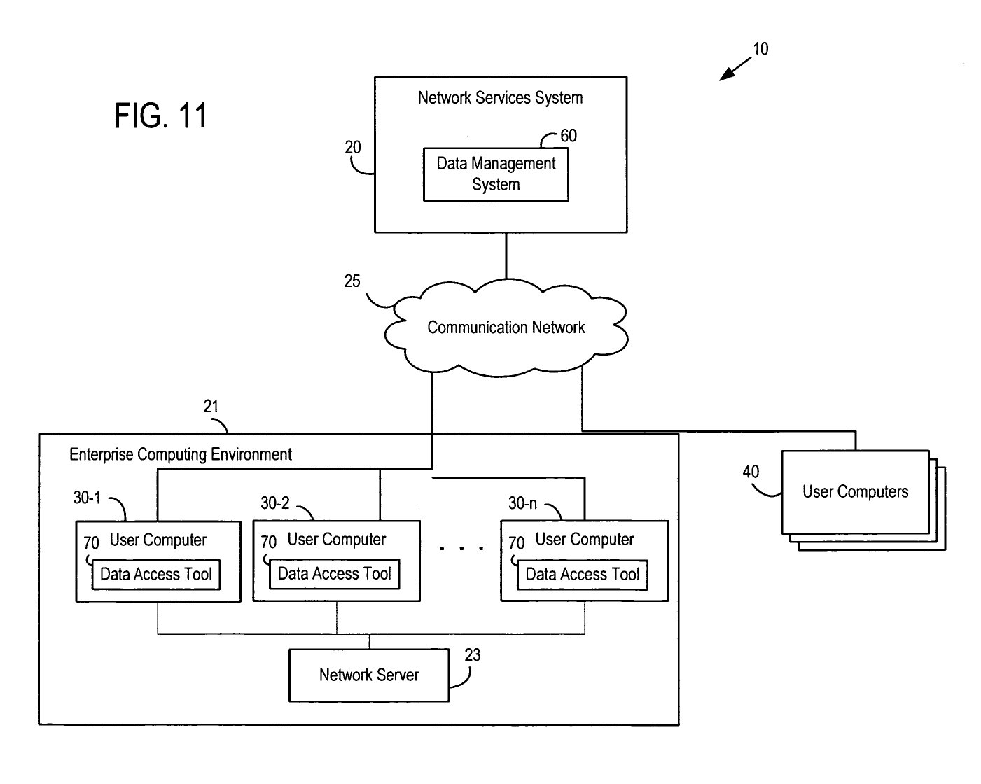

Referring now to FIG. 11, an embodiment of a system 10 is shown. The system 10 comprises a network services system 20, user computers 30, and user computers 40. The network services system 20 permits user computers 30 and 40 to access data in the data management system 60 through computer network 25. In an exemplary embodiment, an enterprise computing environment 21 is shown. Enterprise computing environment 21 includes a client network server 23, a plurality of user computers 30-1, 30-2 and 30-n, and a plurality of data access tool 70. In an exemplary embodiment, client network server 23 stores data files that are not part of the ASP services. Client network server 23 is configured to store files that are not stored on network services system 20. Plurality of user computers 30-1, 30-2 and 30-n are utilized by individual employees of a single customer of the ASP to access the ASP services, network services system 20 and client network server 23. Plurality of user computers 30-1, 30-2 and 30-n include data access tool 70. Data access tool 70 is configured to work with various software packages (i.e. Visio®, Powerpoint®, Excel®, Access®, any Microsoft® software program and/or other non-Microsoft® software program).

Enterprise computing environment 21 allows the users to utilize network services system 20 while not utilizing client network server 23. In an exemplary embodiment, the user could utilize both client network server 23 and network services system 20. This flexibility may create significant cost and technological advantages for a customer of the ASP because the customer may have common access to files by multiple different users in the enterprise while at the same time permitting the files to be accessed by the ASP. The customer may not need or may be able to reduce the size of the customer's client network server 23. In an exemplary embodiment, the customer can reduce their client network server 23 demands because of a reduction in storage or network capacity.

According to other various alternative and exemplary embodiments, the data management application may be used by entities other than application service providers. For example, the application may be configured for use by a company for collaborating in real-time with its customers (or suppliers or other parties), such as on the creation of certain documents, presentations, or other files.

It is important to note that the term “data management system” is intended to be a broad term and not a term of limitation. According to various alternative and exemplary embodiments, the data management system may be used with any of a variety of different hardware, software, programs, applications, etc. and is not intended to be limited to use by application service providers, but may be used by one or more of a variety of different entities in any arrangement where the functionality of the data management application (e.g., the addition of out of network files to a user's Windows Explorer interface, the ability to manipulate remote files in the same way local files are manipulated, etc.) is desirable.

The invention is described above with reference to drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention have been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A system, comprising:
a database;
a file server coupled to the database;
an application service provider interface logic coupled to the file server, the application service provider interface logic being configured to receive commands via a communication network from a client device to access a data file in the database and to cooperate with the client device to cause the data file to be displayed as a local system file in a file directory on the client device.

2. The system of claim 1, further comprising the file server cooperates with the client device to display a portion of a data file on the client device;
wherein the portion of a data file is configured to be modified by the client device; and
wherein a modified data file is synchronized with the data file stored in the database.

3. The system of claim 1, wherein the application service provider interface logic receives at least a file command from a plurality of client devices and cooperates with the plurality of client devices to transmit a data file based on a control signal sent by a data access layer logic.

4. The system of claim 1, wherein the application service provider interface logic is configured to include an authentication and token manager logic.

5. The system of claim 1, wherein the client device is configured to include a web based distributed authoring logic.

6. The system of claim 1, wherein the data file is stored on the client device and the database.

7. The system of claim 6, wherein the application service provider interface logic receives at least a file command from a plurality of client devices and cooperates with the plurality of client devices to transmit a data file based on a control signal sent by a data access layer logic.

8. A method for database management, comprising:
storing at least a data file in an application service provider database;
receiving at least a file command from a plurality of client devices to an application service provider server;
displaying the data file as a local system file in a file directory on a client device.

9. The method of claim 8, further comprising communicating a portion of a data file to the client device;
displaying the portion of a data file on at least one client device as a local system file;
modifying the portion of a data file; and
storing a modified data file in the application service provider database.

10. The method of claim 9, wherein the portion of a data file is configured to be modified by the client device; and
wherein a modified data file is synchronized with the data file stored in the database.

11. The method of claim 8, wherein the application service provider server is configured to include a web based distributed authoring and versioning logic.

12. The method of claim 8, wherein an application service provider interface logic receives at least a file command from a plurality of client devices and cooperates with the plurality of client devices to transmit a data file based on a control signal sent by a data access layer logic.

13. The method of claim 12, wherein the receiving at least a file command from a plurality of client devices and cooperates with the plurality of client devices to transmit a data file based on a control signal sent by a data access layer logic occurs via the internet.

14. A system, comprising:
a database;
a file server coupled to the database;
a content template logic;
an application service provider interface logic coupled to the file server, the application service provider interface logic being configured to receive commands via a communication network from a client device to access a data file in the database and to cooperate with the client device to cause the data file to be displayed as a local system file in a file directory on the client device.

15. The system of claim 14, further comprising the file server cooperates with the client device to display a portion of a data file on the client device;
wherein the portion of a data file is configured to be modified by the client device; and
wherein a modified data file is synchronized with the data file stored in the database.

16. The system of claim 14, wherein the application service provider interface logic receives at least a file command from a plurality of client devices and cooperates with the plurality of client devices to transmit a data file based on a control signal sent by a data access layer logic.

17. The system of claim 14, wherein the application service provider interface logic is configured to include an authentication and token manager logic.

18. The system of claim 14, wherein the client device is configured to include a web based distributed authoring logic.

19. The system of claim 14, wherein the data file is stored on the client device and the database.

20. The system of claim 19, wherein the application service provider interface logic receives at least a file command from a plurality of client devices and cooperates with the plurality of client devices to transmit a data file based on a control signal sent by a data access layer logic.

21. A system, comprising:
a database;
a file server coupled to the database;
a content template logic;
an application service provider interface logic coupled to the file server, the application service provider interface logic being configured to receive commands via a communication network from a client device to access a data file in the database and to cooperate with the client device to cause the data file to be displayed as a local system file in a file directory on the client device;
wherein the file server cooperates with the client device to display a portion of a data file on the client device;
wherein the portion of a data file is configured to be modified by the client device;
wherein a modified data file is synchronized with the data file stored in the database; and
wherein the application service provider interface logic receives at least a file command from a plurality of client devices and cooperates with the plurality of client devices to transmit a data file based on a control signal sent by a data access layer logic.

22. The system of claim 21, wherein the application service provider interface logic is configured to include an authentication and token manager logic.

23. The system of claim 21, wherein the client device is configured to include a web based distributed authoring logic.

24. The system of claim 21, wherein the data file is stored on the client device and the database.

25. The system of claim 24, wherein the application service provider interface logic receives at least a file command from a plurality of client devices and cooperates with the plurality of client devices to transmit a data file based on a control signal sent by a data access layer logic.
